(19) United States
(12) Patent Application Publication
(10) Pub. No.: US 2020/0387650 A1
(43) Pub. Date: Dec. 10, 2020

(54) FRACTURING FLUID FLOW-BACK SIMULATION METHOD FOR FRACTURED HORIZONTAL WELL IN SHALE GAS RESERVOIR

(71) Applicant: SouthWest Petroleum University, Chengdu (CN)

(72) Inventors: Yongming LI, Chengdu (CN); Xi CHEN, Chengdu (CN)

(21) Appl. No.: 16/723,689

(22) Filed: Dec. 20, 2019

(30) Foreign Application Priority Data
Jun. 10, 2019 (CN) 201910497349.3

(51) Int. Cl. G06F 30/23

(52) U.S. Cl. CPC G06F 30/23; G06F 2111/10

(57) ABSTRACT

The present invention discloses a fracturing fluid flow-back simulation method for a fractured horizontal well in a shale gas reservoir, comprising the following steps: (1) establishing a fracturing fluid flow-back model for the fractured horizontal well in the shale reservoir to obtain seepage equations in fractures and a matrix; (2) performing orthogonalized grid division on the matrix of the shale reservoir to establish a corresponding relationship between the numbers of fracture line units segmented by the matrix and the numbers of matrix grids; calculating flow exchange capacities between the fracture line units and the matrix grids corresponding thereto, and between the intersected fracture line units; calculating the flow of fluid flowing into a wellbore from the fracture line unit connected to the wellbore at any time, so as to obtain a daily water production capacity during the flow-back process; and (3) calculating a ratio of a cumulative water production capacity to the total amount of fracturing fluid injected into the reservoir during fracturing to obtain a fracturing fluid flow-back rate. The fracturing fluid flow-back simulation method is reliable in principle, and provides theoretical basis for optimizing a continuous closed-in time and predicting production performances after shale reservoir fracturing, thereby overcoming the defects that it is difficult to perform grid division and achieve complex fracture processing.

### TECHNICAL FIELD

The present invention belongs to the field of oil and gas field development, and more particularly relates to a fracturing fluid flow-back simulation method for a fractured horizontal well in a shale gas reservoir.

### BACKGROUND

Shale gas is a novel unconventional natural gas. It is mainly distributed in the form of free and adsorbed state in mud shale, and the main component is methane. Shale reservoirs have ultra-low permeability. Staged fracturing of horizontal wells in shale gas reservoirs has become a key technology for commercial exploitation of shale gas. After conventional reservoir fracturing, the fracturing fluid will intrude into the formation around fractures if flow-back cannot be performed in time, which often causes serious water lock damage and affects the gas well productivity. Compared with conventional reservoirs, the shale reservoirs are often accompanied with a longer closed-in period. A flow-back rate of the fracturing fluid after well opening is mostly less than 50%, and the flow-back rate of some wells is even less than 5%. A large amount of fracturing fluid is retained in the reservoirs (Vengosh A, Jackson R B, Warner N, et al. A critical review of the risks to water resources from unconventional shale gas development and hydraulic fracturing in the United States[J]. Environmental Science & Technology, 2014, 48(15): 8334-8348). However, practices have proved that for some shale gas wells, the lower the flow-back rate of fracturing fluid, the larger the gas well productivity. It can thus be seen that the flow-back of fracturing fluid is the key link affecting the fracturing effect. Therefore, it is necessary to establish a reasonable fracturing fluid flow-back model for a fractured horizontal well in a shale gas reservoir, which is used to carry out flow-back simulation, analyze a gas-water flow law during the flow-back process, study the main factors affecting the fracturing fluid flow-back, so as to provide theoretical guidance for optimizing the closed-in duration and predicating production performances, promote the development of shale gas pressure fracturing theory and improve the shale gas fracturing design level and the drainage control level, and is of great significance for the efficient development of shale gas in China. At present, the fracturing fluid flow-back simulation for fractured horizontal wells in shale gas reservoirs is mainly based on numerical reservoir simulation software (CMG). However, shale reservoir fracturing can produce large-scale hydraulic fractures, part of which are complex fractures with branch structures. The CMG software has great advantages in processing planar straight fractures, but has obvious inadequacies in the processing of complex fractures in the reservoirs, accompanied with relatively large errors in simulation results. For the processing of complex fractures in reservoirs, most of them need to use unstructured grids. However, when there are many fractures and the included angle between the fractures is relatively small, the division of unstructured grids is very difficult.

In summary, a desired fracturing fluid flow-back simulation method for a fractured horizontal well in a shale gas reservoir at present should have the following two characteristics: (1) the grid division should be as simple as possible; (2) the flowing of fluid in complex fractures in the reservoir can be simulated accurately.

### SUMMARY

The object of the present invention is to provide a fracturing fluid flow-back simulation method for a horizontal well in a shale gas reservoir, which is reliable in principle, and provides theoretical basis for optimizing a continuous closed-in time and predicting production performances after shale reservoir fracturing, thereby overcoming the defects that it is difficult for the conventional method to perform grid division and achieve complex fracture processing.

To fulfill said technical object, the present invention provides the following technical solution:

establishing a fracturing fluid flow-back model for the fractured horizontal well in the shale gas reservoir according to the characteristics of the shale gas reservoir and the characteristics of the fractured horizontal well; secondly, solving the model based on a finite difference method to obtain a daily water production capacity and a daily gas production capacity during the flow-back process; and finally, solving a cumulative water production capacity according to the daily water production capacity, and calculating a ratio of the cumulative water production capacity to the total amount of fracturing fluid injected into the reservoir during fracturing to obtain a flow-back rate of the fracturing fluid, thereby realizing flow-back simulation for the fractured horizontal well in the gas reservoir.

A fracturing fluid flow-back simulation method for a horizontal well in a shale gas reservoir sequentially comprises the following steps:

(1) establishing a fracturing fluid flow-back model for the fractured horizontal well in the shale reservoir, and assuming that the outer boundary of the model is a closed boundary. After shale fracturing is ended, the fracturing fluid is mainly distributed in fractures and matrix intrusion zones around the fractures. Under the action of capillary forces, the fracturing fluid in the intrusion zones will further infiltrate deep into the reservoir. Therefore, the seepage in the matrix and the fractures during the flow-back process is gas-water two-phase flow. For two-dimensional reservoirs, the flowing in the normal direction of the fracture wall surface is ignored, and the fluid flows along the fractures in one dimension. Based on the basic principles of seepage mechanics (Li Xiaoping. Underground Oil and Gas Seepage Mechanics [M]. Petroleum Industry Press, 2018), a seepage equation in the fractures and the matrix can be obtained.

1) seepage equation in fractures

seepage equation of the aqueous phase:

$$\frac{\partial }{\partial ξ} ( β \frac{{K}_{F} {K}_{Frw}}{{μ}_{w} {B}_{w}} \frac{\partial }{\partial ξ} ( {P}_{F} - {P}_{F c} ) ) + \frac{{q}_{F w} + {Q}_{m F w} + {δ}_{F} {Q}_{F F w}}{{V}_{F}} = \frac{\partial }{\partial t} ( \frac{{φ}_{F} {S}_{F w}}{{B}_{w}} ) \qquad ( 1 )$$

where: β is a unit conversion factor, 10⁻³;

ξ is a local coordinate system in a fracture direction;

K_{F} is an absolute permeability of the fractures, D;

K_{Frw} is the relative permeability of the aqueous phase in the fractures, no dimension;

P_{F} is a pressure of the aqueous phase in the fractures, MPa;

μ_{w} is the viscosity of the aqueous phase, mPa·s;

B_{w} is a volume coefficient of the aqueous phase, m³/m³;

q_{Fw} is the amount of water flowing into the wellhole from the fractures, m³/s;

Q_{mFw} is a flow channeling rate of the aqueous phase between the matrix and the fractures, m³/s;

Q_{FFw} is a flow exchange capacity of the aqueous phase between fractures and the intersected fractures, m³/s;

ϕ_{F} is the porosity of the fractures, no dimension;

S_{Fw} is a water saturation in the fractures, no dimension;

V_{F} is a volume of the fracture unit, m³;

P_{Fc} is a capillary force in the fractures, MPa; and

δ_{F} takes 1 or 0, and when the fracture is intersected with other fractures, δ_{F} takes 1 and vice versa.

seepage equation of the gaseous phase:

$$\frac{\partial }{\partial ξ} ( β \frac{{K}_{F} {K}_{F r g}}{{μ}_{g} {B}_{g}} \frac{\partial {P}_{F}}{\partial ξ} ) + \frac{{q}_{F g} + {Q}_{m F g} + {δ}_{F} {Q}_{F F g}}{{V}_{F}} = \frac{\partial }{\partial t} ( \frac{{φ}_{F} ( 1 - {S}_{F w}}{{B}_{g}} ) \qquad ( 2 )$$

Where, K_{Frg} is a relative permeability of the gaseous phase in the fractures, no dimension;

μ_{g} is the viscosity of the gaseous phase, mPa·s;

B_{g} is a volume coefficient of the gaseous phase, m³/m³;

q_{Fg} is the amount of gas flowing into the wellhole in the fractures, m³/s;

Q_{mFg} is a flow channeling rate of the gaseous phase between the matrix and the fractures, m³/s; and

Q_{FFg} is a flow exchange capacity of the gaseous phase between a fracture and fractures intersected therewith, m³/s.

With respect to the flow exchange capacities Q_{mFw}, Q_{mFg} (the flow channeling rates) of the aqueous phase and the gaseous phase between the matrix and the fractures in Equations (1) and (2), it is only necessary to multiply the relative permeabilities of the aqueous and gaseous phases in the matrix based on a single-phase fluid channeling formula (Yan Xia, Huang Chaoqin, Yao Jun, et al., Mathematical Model of Embedded Discrete Fractures based on Simulated Finite Difference [J]. Science in China: Technical Science, 2014 (12): 1333-1342):

Q_{mFl}=T_{mF}Kₘᵣₗ(Pₘ−P_{F})l=w,g (3)

where: w corresponds to the aqueous phase;

g corresponds to the gaseous phase; and

Kₘᵣₗ is the relative permeability of the gaseous phase or aqueous phase in the matrix, no dimension.

A wellhead-like circulation coefficient T_{mF} is calculated by adopting the following equation:

$${T}_{m F} = \frac{{K}_{m F} {A}_{m F}}{{μ}_{l} \overline{d}} \qquad ( 4 )$$

where, K_{mF} is a harmonic mean of the permeabilities of the matrix and the fractures, D;

A_{mF} is a contact area between the fractures and the matrix, m²; and

d̅ is an average distance between each point in the matrix and the fracture, m.

The flow exchange capacities Q_{FFw}, Q_{FFg} of the aqueous phase and the gaseous phase between the matrix and the fractures in Equations (1) and (2) are calculated based on the similarity principle of galvanic electricity by using the method of calculating a series resistance in a circuit. In the case that n fractures intersect, the flow exchange capacity between the fracture and the remaining n−1 fractures is expressed as:

$${Q}_{F F l} = \frac{2 \frac{{K}_{F ω} {w}_{ω} {h}_{F}}{{μ}_{l} {L}_{ω}}}{{\sum }_{λ = 1}^{n} \frac{{K}_{F λ} {w}_{λ} {h}_{F}}{{μ}_{l} {L}_{λ}}} [ {\sum }_{j = 1}^{n} \frac{{K}_{{F}_{i}} {w}_{i} {h}_{F}}{{μ}_{l} {L}_{i}} {K}_{Frl ω j +} ( {P}_{F ω} - {P}_{Fj} ) ] ω , \\ j ⋐ [ 1 , n ] \qquad ( 5 )$$

where, K_{Frlωj+} is the relative permeability of the gaseous phase or aqueous phase at the upstream points of the intersected fractures ω, j, no dimension;

P_{Fω} and P_{Fj} are the pressures of the fractures ω, j, respectively, MPa;

K_{Fω} and K_{Fj} are the permeabilities of the fractures w respectively, D;

w_{ω} and wⱼ are the widths of the fractures ω, j, respectively, m;

L_{ω} and Lⱼ are the lengths of the fractures ω, j, respectively, m; and

h_{F} is a fracture height, m.

Equation (5) is derived as follows:

In the case that n fractures intersect and the intersection point is O, according to the Darcy's law, the flow of fluid flowing into the node O through the fracture j is:

$${Q}_{jO} = - \frac{{K}_{{F}_{j}} {w}_{j} {h}_{F}}{μ} \frac{{P}_{F O} - {P}_{{F}_{j}}}{0.5 {L}_{j}} \qquad ( 6 )$$

where, μ is the viscosity of the fluid, mPa·s; and

P_{FO} is a pressure at the fracture node, MPa

It is set that

$${T}_{jO} = - \frac{2 {K}_{{F}_{j}} {w}_{j} {h}_{F}}{μ {L}_{j}} ,$$

and according to the similarity principle of galvanic electricity, the equivalent circulation conductivity T_{ωj} between the fracture ω and the fracture j intersected therewith is expressed as (M. Karimi-Fard, L. J. Durlofsky, K. Aziz. An Efficient Discrete-Fracture Model Applicable for General-Purpose Reservoir Simulators[J]. SPE Journal, 2004, 9(2):227-236):

$${T}_{ω j} = \frac{{T}_{ω O} {T}_{j O}}{{{\sum }^{n}}_{λ = 1} {T}_{λ O}} \qquad ( 7 )$$

in the case of a gas-water two-phase flow, it is only necessary to multiply the permeability of the gaseous phase or the relative permeability before the equivalent flow circulation conductivity, and meanwhile, the viscosity μ in the equivalent circulation conductivity corresponds to the viscosity of the gaseous phase and the aqueous phase. Therefore, the flow exchange capacity between the fracture ω and the fracture j intersected therewith is expressed as:

$${Q}_{l ω j} = \frac{2 \frac{{K}_{F ω} {w}_{ω} {h}_{F}}{{μ}_{l} {L}_{ω}} {K}_{Fj} {w}_{j} {h}_{F}}{{\sum }_{λ = 1}^{n} \frac{{K}_{F λ} {w}_{λ} {h}_{F}}{{μ}_{l} {L}_{λ}} {μ}_{l} {L}_{j}} {K}_{F r {l}_{ω j} +} ( {P}_{F ω} - {P}_{Fj} ) \qquad ( 8 )$$

The flow exchange capacity between the fracture ω and each fracture intersected therewith is obtained according to Formula (8), and the flow exchange amounts are then superposed to obtain the flow exchange capacity between the fracture ω and the remaining n−1 fractures, that is Formula (5).

2) seepage equation in matrix

seepage equation of the aqueous phase:

$$∇ ( β \frac{{K}_{m 0} {K}_{mrw}}{{μ}_{w} {B}_{w}} ∇ ( {P}_{m} - {P}_{m c} ) ) - \frac{{Q}_{m F w} \cdot {δ}_{m}}{{V}_{m}} = \frac{\partial }{\partial t} ( \frac{{φ}_{m} {S}_{m w}}{{B}_{w}} ) \qquad ( 9 )$$

Where, K_{mrw} is the relative permeability of the gaseous phase in the fracture, no dimension;

Kₘ₀ is the absolute permeability of shale matrix, D;

Pₘ is a pressure of the gaseous phase in the matrix, MPa;

Vₘ is a volume of a grid unit of the matrix, m³;

ϕₘ is the porosity of the matrix, no dimension;

S_{mw} is a water saturation in the matrix, no dimension;

P_{mc} is a capillary force in the matrix, MPa; and

δₘ takes 0 or 1, and when no fracture embedding occurs in the matrix, δₘ takes 0 and vice versa;

Considering the shale gas adsorption and desorption in the matrix, a differential equation of gaseous phase seepage in the matrix is expressed as:

$$∇ ( β \frac{{K}_{m} {K}_{m r g}}{{μ}_{g} {B}_{g}} ∇ {P}_{m} ) - \frac{{Q}_{m F g} \cdot {δ}_{m}}{{V}_{m}} = \frac{\partial }{\partial t} ( \frac{{φ}_{m} ( 1 - {S}_{m w} )}{{B}_{g}} + \frac{{ρ}_{s} {V}_{L} {P}_{m}}{{P}_{m} + {P}_{L}} ) \qquad ( 10 )$$

Where, K_{mrg} is the relative permeability of the gaseous phase in the fracture, no dimension;

Kₘ is the apparent permeability of the gaseous phase in the shale matrix, D;

ρₛ is the density of the shale matrix, kg/m³;

V_{L} is the Langmuir volume, m³/kg; and

P_{L} is the Langmuir pressure, MPa.

The shale matrix has nanopores. Based on the B-K model (Zhu Weiyao, Deng Jia, Yang Baohua, et al., Seepage Model of Shale Gas Dense Reservoir and Productivity Analysis of Fractured Vertical Well[J]. Mechanics and Practice, 2014, 36 (2): 156-160), the apparent permeability in consideration of multi-scale flowing of shale gas is as follows:

$${K}_{m} = {K}_{m 0} ( 1 + a {K}_{n} ) ( 1 + \frac{4 {K}_{n}}{1 - b {K}_{n}} ) \qquad ( 11 )$$

where, a is a sparse coefficient, no dimension;

b is a slip coefficient, no dimension; and

Kₙ is a Knudsen number, no dimension.

(2) solving the model based on a finite difference method

1) performing orthogonalized grid division on the matrix of the shale reservoir, wherein the number of grids in the x direction is nₓ, and the number of grids in the y direction is n_{y}; recording an x-direction grid step length and a y-direction grid step length of each matrix grid, and coordinates of four vertices of each matrix grid, wherein the fractures are divided into line units of a certain length by the matrix grids; and recording the length of each fracture line unit formed by the fractures segmented by the matrix, and the coordinates of end points of each fracture line unit.

2) establishing a one-to-one corresponding relationship between the numbers of the fracture line units segmented by the matrix and the numbers of the matrix grids: naturally sorting the matrix grids by rows, that is, the first row of the matrix grids is numbered from left to right in order of 1, 2, 3, . . . , nₓ, and the second row of the matrix grids is numbered from left to right in order of nₓ+1, nₓ+2, nₓ+3, . . . , 2×nₓ till all the matrix grids are numbered; sequentially numbering the fracture line units, that is, the first fracture grid is numbered as 1, 2, 3, . . . , n_{f1}, and the second fracture grid is numbered as n_{f1}+1, n_{f1}+2, n_{f1}+3, . . . , n_{f1}+n_{f2} till all the fracture grids are numbered; according to the information on vertices of the matrix grids and the information on end points of the fracture line units in 1), when both end points of each fracture line unit are located in an area formed by four vertices of a matrix grid, it is considered that fracture embedding occurs in the matrix grid; identifying the numbers of the fracture line units and the numbers of the matrix grids to establish a one-to-one corresponding relationship between the numbers of the fracture line units segmented by the matrix and the numbers of the matrix grids.

3) calculating the flow exchange capacity between the fracture line units segmented by the matrix and the matrix grids corresponding thereto according to Formulas (3) and (4);

4) calculating the flow exchange capacity between the intersected fracture line units according to Formula (5);

5) calculating the amount of water or gas flowing into the wellhole from the fractures;

for a bottomhole flow pressure boundary, the wellhole friction is ignored. The pressure at each wellhole in the fracture connected to the wellhole is equal to the bottomhole flow pressure. Based on a method for processing a model in which a vertical well passes through a multi-layer well in numerical simulation of oil and gas reservoirs (Turgay Ertekin. Practical Reservoir Simulation Technology [M]. Petroleum Industry Press, 2004), in the case of considering only the fluid flowing into the wellhole from the fractures, the relationship between the pressure of each fracture passing through the wellhole and the flow (gas production capacity, water production capacity) under standard conditions is established. Assuming that the number of fractures connected to the wellhole is m, the amounts of water and gas flowing into the wellhole from the fractures are calculated by the following formula:

$${q}_{F l} = {\sum }_{i = 1}^{m} \frac{2 π β {K}_{Fi} {K}_{Frli} {w}_{i} ( {P}_{Fi} - {P}_{w f} )}{{μ}_{l} {B}_{l} ln ( {0.14 [ {( {L}_{i} )}^{2} + {( {h}_{F} )}^{2} ]}^{1 / 2} \text{/} {r}_{w} )} l = w , g \qquad ( 12 )$$

where, q_{Fl} is the amount of water or gas flowing into the wellhole from the fracture, m³/s, l=w, g;

r_{w} is a well radius, m;

K_{Frli} is the relative permeability of the aqueous phase or the gaseous phase in a fracture i;

P_{wf} is a bottomhole flow pressure, MPa;

Lᵢ is a length of the i^{th} fracture connected to the wellhole, m;

K_{Fi} is the permeability of the fracture i, D;

wᵢ is a width of the fracture i, m; and

P_{Fi} is a pressure of the fracture i, MPa.

6) performing finite differential discretization on Equations (1), (2), (9), and (10) according to the information on grid division of the grid matrix and the fractures; substituting the calculated flow exchange capacity between the fracture line units and the matrix grids corresponding thereto and the flow exchange capacity between the intersected fracture line units into a differential equation set; simultaneously estimating Formula (12); and solving the differential equation set to obtain the flow (gas production capacity and the water production capacity) of the fluid flowing into the wellhole from the fracture line unit connected to the wellhole at any moment, thereby obtaining the daily water production capacity and the daily gas production capacity during the back-flow process.

(3) Solving a cumulative water production capacity according to the daily water production capacity; and calculating a ratio of the cumulative water production capacity to the total volume of fracturing fluid injected into the reservoir during fracturing to obtain a flow-back rate of the fracturing fluid, thereby realizing flow-back simulation for the fractured horizontal well in the shale gas reservoir.

### BRIEF DESCRIPTION OF THE DRAWINGS

FIG. 1 is a schematic diagram of grid division of a reservoir.

FIG. 2 is a curve showing the daily gas production capacity during the flow-back process.

FIG. 3 is a curve of water production capacity during the flow-back process.

FIG. 4 is a graph showing a flow-back rate.

### DETAILED DESCRIPTION

The present invention will be further described in detail below with reference to the drawings and field application examples.

Taking a horizontal well in a shale gas reservoir in the Southwest area in China as an example, the reservoir depth is 2948-2998 m, the thickness is 50 m, the average porosity of the gas reservoir is 4.6%, and the average permeability is 5×10⁻⁷D. It belongs to a low porosity and low permeability reservoir. This well is fractured using the technical method of a liquid system (mainly based on slippery water) having large displacement, low sand ratio, large fluid volume and low viscosity, and the number of fractured stages is 13. The cumulative injection of fracturing fluid is 10417 m³, and the final flow-back rate of this well is 21.6%. Other basic parameters are shown in Table 1 below.

TABLE 1
basic parameter table

| Parameters | Values | Parameters | Values |
|---|---|---|---|
| Original pressure of reservoir | 30 | Reservoir temperature (K) | 352 |
| (MPa) | | | |
| Porosity of matrix | 4.6% | Size of reservoir (m) | 1000 × 500 |
| Fracture permeability (D) | 5 | Fracture width (m) | 0.005 |
| Initial water saturation of | 1 | Fracture porosity | 0.5 |
| fracture | | | |
| Initial water saturation of | 0.35 | Irreducible water saturation | 0 |
| matrix | | of fracture | |
| Fracturing fluid intrusion | 3.6 | Water saturation of intrusion | 0.85 |
| depth around single fracture, | | zone | |
| m | | | |
| Langmuir pressure (MPa) | 4.48 | Irreducible water saturation | 0.35 |
| | | of matrix | |
| Viscosity of fracturing fluid | 1 | Langmuir volume, m³/kg; | 0.00272 |
| (mPa · s) | | | |
| Well radius (m) | 0.06 | Flowing bottomhole pressure | 25 |
| | | (MPa) | |

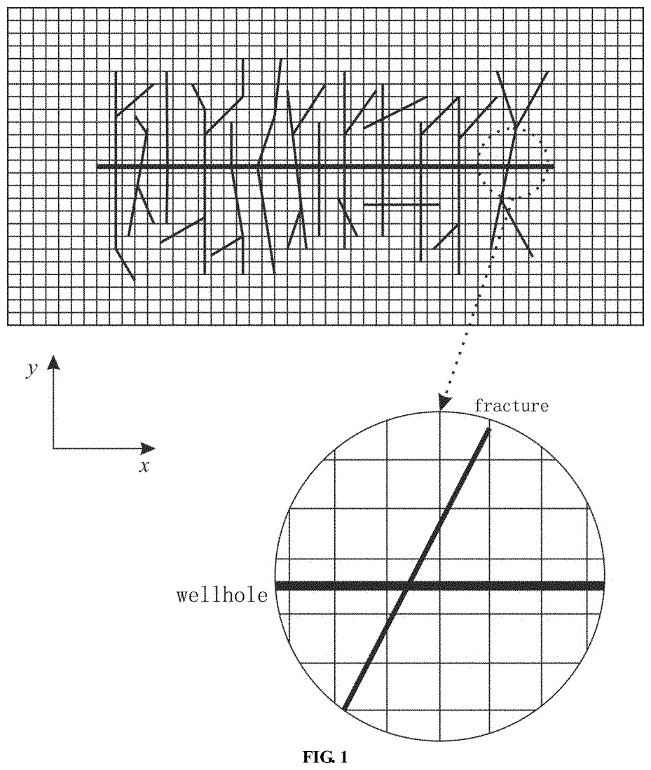

In step 1, the matrix in the reservoir is subjected to orthogonalized grid division according to the data in Table 1. The schematic diagram of the grids is as shown in FIG. 1.

In step 2, the matrix grids are numbered in a natural order in rows. Meanwhile, the fracture line units segmented by the matrix grids are numbered, a one-to-one corresponding relationship between the numbers of the fracture line units segmented by the matrix and the numbers of the matrix grids is established, and the flow exchange capacity between the fracture line units segmented by the matrix and the matrix grids is calculated according to Formula (3) and (4).

In step 3, the intersected fracture line units are identified, the flow exchange relationship between the intersected fracture units is established, and the flow exchange capacity between the intersected fracture line units is calculated according to Formula (5).

In step (4), seepage equations (1), (2), (9), and (10) are subjected to differential discretization, the calculated flow exchange capacity between the fracture line units and the matrix grids corresponding thereto and the flow exchange capacity between the intersected fracture line units are substituted into a differential equation set, Equation (12) is simultaneously estimated, to obtain a general form of the finite differential equation set according to the corresponding boundary conditions and initial conditions.

In step 5, the differential equation set is solved by adopting an interactive method to solve the flow of fluid flowing into the wellhole from the fracture line unit connected to the wellhole. The flows of the fluid flowing into the wellhole from respective fracture line units are superposed to obtain the daily gas production capacity and the daily water production capacity during the flow-back process. A ratio of the cumulative water production capacity to the total injection fracturing amount, i.e., the flow-back rate of the fracturing liquid, is then calculated. Therefore, the flow-back simulation of the fracturing liquid in the fractured horizontal well of the shale reservoir is realized.

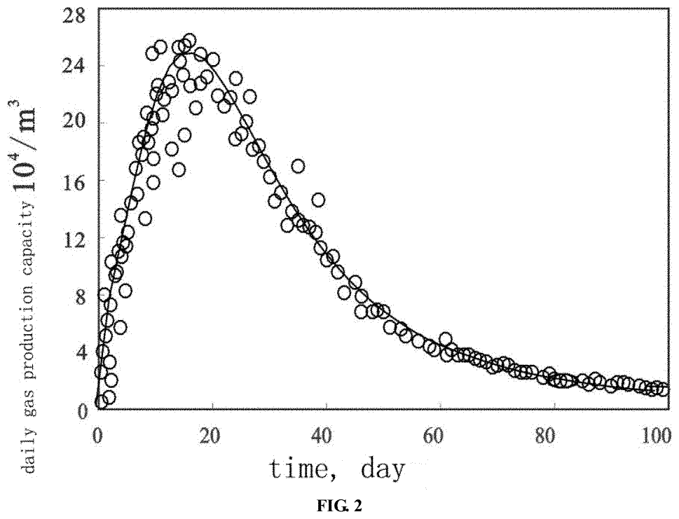

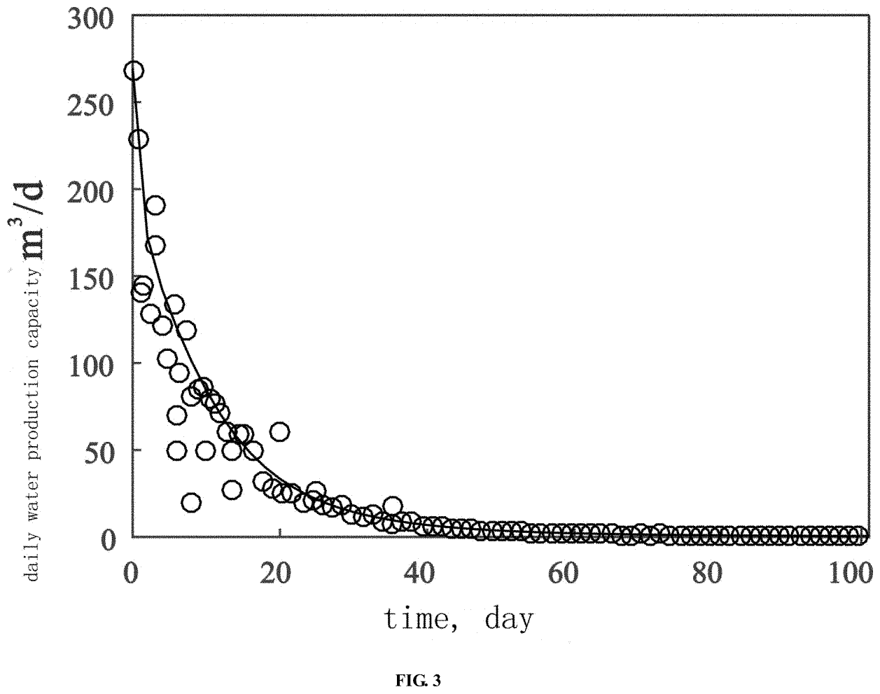

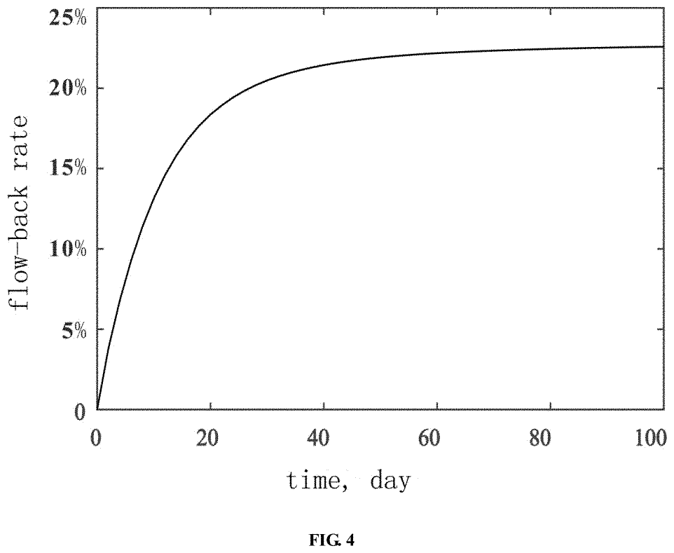

As observed from FIG. 2 and FIG. 3, the daily gas production capacity curve and the cumulative gas production capacity curve obtained by the above steps fit well with actual field data. As observed from FIG. 4, the final fracturing fluid flow-back rate is stabilized at about 23%, the on-site flow-back rate of this well is 21.6%, and the error between the simulation result and the actual flow-back rate is relatively small, indicating that the fracturing liquid flow-back simulation method for the fractured horizontal well in the shale gas reservoir proposed by the present invention is relatively reasonable, and is of great significance for flow-back simulation and post-fracturing production performance prediction of the shale reservoir. Moreover, the grids in the present invention are orthogonalized structural grids, such that the grid division has no dependence on the distribution of fractures, which is convenient for simulating the fracturing fluid flow-back law under complex fractures.

1. A fracturing fluid flow-back simulation method for a fractured horizontal well in a shale gas reservoir, sequentially comprising the following steps:
(1) establishing a fracturing fluid flow-back model for the fractured horizontal well in the shale reservoir, in which seepage in a matrix and fractures during the flow-back process is gas-water two-phase flow, to obtain a seepage equation in the fractures and the matrix:
1) seepage equation in fractures
seepage equation of an aqueous phase:
$$\frac{\partial }{\partial ξ} ( β \frac{{K}_{F} {K}_{Frw}}{{μ}_{w} {B}_{w}} \frac{\partial }{\partial ξ} ( {P}_{F} - {P}_{F c} ) ) + \frac{{q}_{F w} + {Q}_{m F w} + {δ}_{F} {Q}_{F F w}}{{V}_{F}} = \frac{\partial }{\partial t} ( \frac{{φ}_{F} {S}_{F w}}{{B}_{w}} )$$
seepage equation of a gaseous phase:
$$\frac{\partial }{\partial ξ} ( β \frac{{K}_{F} {K}_{F r g}}{{μ}_{g} {B}_{g}} \frac{\partial {P}_{F}}{\partial ξ} ) + \frac{{q}_{F g} + {Q}_{m F g} + {δ}_{F} {Q}_{F F g}}{{V}_{F}} = \frac{\partial }{\partial t} ( \frac{{φ}_{F} ( 1 - {S}_{F w} )}{{B}_{g}} )$$
where: β is a unit conversion factor, 10⁻³;
ξ is a local coordinate system in a fracture direction;
K_{F} is the absolute permeability of the fractures, D;
K_{Frw} and K_{Frg} are relative permeabilities of the aqueous phase and the gaseous phase in the fractures respectively, no dimension;
P_{F} is a pressure of the aqueous phase in the fractures, MPa;
μ_{w} and μ_{g} are the viscosity of the aqueous phase and the viscosity of the gaseous phase respectively, mPa·s;
B_{w} and B_{g} are volume coefficients of the aqueous phase and the gaseous phase respectively, m³/m³;
q_{Fw} and q_{Fg} are amounts of water and gas flowing into the wellhole from the fractures, m³/s;
Q_{mFw} and Q_{mFg} are fluid-channeling rates of the aqueous phase and the gaseous phase between the matrix and the fractures, m³/s;
Q_{FFw} and Q_{FFg} are flow exchange volumes of the aqueous phase and the gaseous phase between a fracture and fractures intersected therewith, m³/s;
ϕ_{F} is the porosity of the fractures, no dimension;
S_{Fw} is a water saturation in the fractures, no dimension;
V_{F} is a volume of the fracture unit, m³;
P_{Fc} is a capillary force in the fractures, MPa;
δ_{F} takes 1 or 0, and when the fracture is intersected with other fractures, δ_{F} takes 1 and vice versa;
2) seepage equation in matrix
seepage equation of the aqueous phase:
$$∇ ( β \frac{{K}_{m 0} {K}_{mrw}}{{μ}_{w} {B}_{w}} ∇ ( {P}_{m} - {P}_{m c} ) ) - \frac{{Q}_{m F w} \cdot {δ}_{m}}{{V}_{m}} = \frac{\partial }{\partial t} ( \frac{{φ}_{m} {S}_{m w}}{{B}_{w}} )$$
seepage equation of the gaseous phase:
$$∇ ( β \frac{{K}_{m} {K}_{m r g}}{{μ}_{g} {B}_{g}} ∇ {P}_{m} ) - \frac{{Q}_{m F g} \cdot {δ}_{m}}{{V}_{m}} = \frac{\partial }{\partial t} ( \frac{{φ}_{m} ( 1 - {S}_{m w} )}{{B}_{g}} + \frac{{ρ}_{s} {V}_{L} {P}_{m}}{{P}_{m} + {P}_{L}} )$$
where, K_{mrw} and K_{mrg} are the relative permeabilities of the aqueous phase and the gaseous phase of the matrix respectively, no dimension;
Kₘ₀ is the absolute permeability of shale matrix, D;
Pₘ is a pressure of the gaseous phase in the matrix, MPa;
Vₘ is a volume of a grid unit of the matrix, m³;
ϕₘ is the porosity of the matrix, no dimension;
S_{mw} is a water saturation in the matrix, no dimension;
P_{mc} is a capillary force in the matrix, MPa;
δₘ takes 0 or 1, and when no fracture embedding occurs in the matrix, δₘ takes 0 and vice versa;
Kₘ is the apparent permeability of the gaseous phase in the shale matrix, D;
ρₛ is the density of the shale matrix, kg/m³;
V_{L} is the Langmuir volume, m³/kg;
P_{L} is the Langmuir pressure, MPa;
(2) solving the model based on a finite difference method
1) performing orthogonalized grid division on the matrix of the shale reservoir, wherein the number of grids in the x direction is nₓ, and the number of grids in the y direction is n_{y}; recording a x-direction grid step length and a y-direction grid step length of each matrix grid, and coordinates of four vertices of each matrix grid, wherein the fractures are divided into line units by the matrix grids; and recording the length and the coordinates of end points of each fracture line unit;
2) naturally sorting the matrix grids by rows, that is, the first row of the matrix grids is numbered from left to right in order of 1, 2, 3, . . . , nₓ, and the second row of the matrix grids is numbered from left to right in order of nₓ+1, nₓ+2, nₓ+3, . . . , 2×nₓ; sequentially numbering the fracture line units, that is, the first fracture grid is numbered as 1, 2, 3, . . . , n_{f1}, and the second fracture grid is numbered as n_{f1}+1, n_{f1}+2, n_{f1}+3, . . . , n_{f1}+n_{f2}, wherein when both end points of each fracture line unit are located in an area formed by four vertices of a matrix grid, it is considered that fracture embedding occurs in the matrix grid; and identifying the numbers of the fracture line units and the numbers of the matrix grids to establish a one-to-one corresponding relationship between the numbers of the fracture line units segmented by the matrix and the numbers of the matrix grids;
3) calculating a flow exchange capacity between the fracture line units segmented by the matrix and the matrix grids corresponding thereto;
4) calculating a flow exchange capacity between the intersected fracture line units;
5) assuming that the number of fractures connected to the wellhole is m, calculating the amounts of water and gas flowing into the wellhole from the fractures according to the following formula:
$${q}_{F l} = {\sum }_{i = 1}^{m} \frac{2 π β {K}_{Fi} {K}_{Frli} {w}_{i} ( {P}_{Fi} - {P}_{w f} )}{{μ}_{l} {B}_{l} ln ( {0.14 [ {( {L}_{i} )}^{2} + {( {h}_{F} )}^{2} ]}^{1 / 2} \text{/} {r}_{w} )} l = w , g$$
where, q_{Fl} is the amount of water or gas flowing into the wellhole from the fracture, m³/s, l=w, g;
r_{w} is a well radius, m;
K_{Frli} is the relative permeability of the aqueous phase or the gaseous phase in a fracture i;
P_{wf} is a bottom hole flow pressure, MPa;
Lᵢ is a length of the i^{th} fracture connected to the wellhole, m;
K_{Fi} is the permeability of the fracture i, D;
wᵢ is a width of the fracture i, m;
P_{Fi} is a pressure of the fracture i, MPa;
6) performing finite differential discretization on the seepage equation of the step (1) according to the information on grid division of the grid matrix and the fractures, substituting the flow exchange capacity between the fracture line unit and the matrix grid corresponding thereto and the flow exchange capacity between the intersected fracture line units into a differential equation set, and calculating the flow of fluid flowing into the wellhole from the fracture line unit connected to the wellhole at any time in combination with the calculation formula in step 5), so as to obtain a daily water production capacity and a daily gas production capacity during the flow-back process; and
(3) solving a cumulative water production capacity according to the daily water production capacity, and calculating a ratio of the cumulative water production capacity to the total amount of fracturing fluid injected into the reservoir during fracturing to obtain a fracturing fluid flow-back rate.

2. The fracturing fluid flow-back simulation method for a fractured horizontal well in a shale gas reservoir according to claim 1, wherein the step of calculating the flow exchange capacity between the fracture line units segmented by the matrix and the matrix grids corresponding thereto in 3) of (2) includes the following process:
$${Q}_{m F l} = {T}_{m F} {K}_{m r l} ( {P}_{m} - {P}_{F} ) l = w , g$$
$${T}_{m F} = \frac{{K}_{m F} {A}_{m F}}{{μ}_{l} \overline{d}}$$
where: w corresponds to an aqueous phase;
g corresponds to a gas phase;
Kₘᵣₗ is the relative permeability of the gaseous phase or aqueous phase in the matrix, no dimension;
Pₘ and P_{F} are the pressures of the gaseous phases in the matrix and the fractures, respectively, MPa;
K_{mF} is a harmonic mean of the permeabilities of the matrix and the fractures, D;
A_{mF} is a contact area between the fractures and the matrix, m²; and
d̅ is an average distance between each point in the matrix and the corresponding fracture, m.

3. The fracturing fluid flow-back simulation method for a fractured horizontal well in a shale gas reservoir according to claim 1, wherein the step of calculating a flow exchange capacity between the intersected fracture line units in 4) of (2) includes the following process:
in the case where n fractures are intersected, the flow exchange capacity between the fracture ω and the remaining n−1 fractures is expressed as:
$${Q}_{F F l} = \frac{2 \frac{{K}_{F ω} {w}_{ω} {h}_{F}}{{μ}_{l} {L}_{ω}}}{{\sum }_{λ = 1}^{n} \frac{{K}_{F λ} {w}_{λ} {h}_{F}}{{μ}_{l} {L}_{λ}}} [ {\sum }_{j = 1}^{n} \frac{{K}_{Fj} {w}_{j} {h}_{F}}{{μ}_{l} {L}_{j}} {K}_{F r {l}_{ω j} +} ( {P}_{F ω} - {P}_{Fj} ) ] ω , \\ j ⋐ [ 1 , n ]$$
where: K_{Frlω+} is the relative permeability of the gaseous phase or aqueous phase at the upstream points of the intersected fractures ω, j, no dimension;
P_{Fω} and P_{Fj} are the pressures of the fractures ω, j, respectively, MPa;
K_{Fω} and K_{Fj} are the permeabilities of the fractures ω, j, respectively, D;
w_{ω} and wⱼ are the widths of the fractures ω, j, respectively, m;
L_{ω} and Lⱼ are the lengths of the fractures ω, j, respectively, m; and
h_{F} is a fracture height, m.
